(19) United States
(12) Patent Application Publication
(10) Pub. No.: US 2025/0013612 A1
(43) Pub. Date: Jan. 9, 2025

(54) MESH STORAGE NETWORK

(71) Applicant: DISH Network L.L.C., Englewood, CO (US)

(72) Inventors: Luke VanDuyn, Conifer, CO (US); Caroline Elizabeth Condon, Denver, CO (US); Isha Kanu, Denver, CO (US); Marianna Hernandez, Aurora, CO (US)

(73) Assignee: DISH Network L.L.C., Englewood, CO (US)

(21) Appl. No.: 18/218,362

(22) Filed: Jul. 5, 2023

(51) Int. Cl. G06F 16/182; G06F 16/11; H04L 9/40

(52) U.S. Cl. CPC G06F 16/1827; G06F 16/122; H04L 63/10; H04L 63/0428

(57) ABSTRACT

A distributed storage system is provided on a wireless local area network formed by a plurality of peer mesh storage devices simultaneously wirelessly connected together. Each peer mesh storage device includes a computing processor, a communication transceiver, and a data storage drive. Upon receiving a first data file from a user device connected to the local area network at one of a plurality of peer mesh storage devices, the system stores the first data file on the data storage drive of one or more of the plurality of mesh storage devices. Upon receipt of a request from a user device for storage of a second data file on the system, the second data file is retrieved from storage on the data storage drive of one or more of the plurality of mesh storage devices and is transmitted over the local area network to the user device.

### TECHNICAL FIELD

The technology described herein relates to a local distributed storage system managed within a wireless mesh local area network.

### BACKGROUND

Recent trends in both business and personal data storage have moved away from local storage on computer hard drives in favor of data storage on remote data servers accessible over the Internet, i.e., in “the cloud.” Benefits of cloud data storage include redundancy, avoidance of reliance on local hard drives, which can crash and leave data inaccessible, and availability of stored data from any location with an Internet connection. Downsides to cloud storage include payment of monthly subscription fees, limits on storage capacity, and the requirement for an Internet connection to access data. Another concern is security and privacy. By transmitting data over the Internet for remote storage on a third-party system, data is subject to interception during transmission as well as access by unscrupulous actors, e.g., hackers seeking personally identifiable or compromising information for purposes of illegal financial gain. “Mesh” wireless local area networks have also become popular to provide better wireless signal coverage in a home or small office environment.

The information included in this Background section of the specification, including any references cited herein and any description or discussion thereof, is included for technical reference purposes and is not to be regarded subject matter by which implementations of the present disclosure and the scope of any inventions defined in any claim arising here from is to be bound.

### SUMMARY

In some example implementations, a mesh storage device is implemented within a local area network and includes a computing processor; a communication transceiver under control of the computing processor; and a data storage drive under control of the computing processor that stores instructions, which when executed by the processor, direct the computing processor to execute application programs in coordination with a plurality of peer mesh storage devices simultaneously wirelessly connected together and with the mesh storage device to form the local area network, the application programs including: a file transfer manager which, when executed by the computing processor, causes the computing processor to: receive a first data file from a user device connected to the local area network, and store the first data file on the data storage drive, on one or more of the plurality of mesh storage devices; and retrieve a second data file requested by the user device from storage on the data storage drive, on one or more of the plurality of mesh storage devices, and cause the retrieved second data file to be transmitted over the local area network to the user device.

In some example implementations, a mesh wireless storage system provides distributed storage on a local area network comprising a network access device and a plurality of peer mesh storages devices simultaneously wirelessly connected together to form the local area network. The peer mesh storage devices each include a computing processor; a communication transceiver under control of the computing processor; and a data storage drive under control of the computing processor that stores instructions, which when executed by the computing processor, direct the computing processor to execute application programs in coordination with the plurality of peer mesh storage devices. The application programs include a file transfer manager which, when executed by the computing processor, causes the computing processor to receive a first data file from a user device connected to the local area network, and store the first data file on the data storage drive of one or more of the plurality of mesh storage devices, and retrieve a second data file requested by the user device from storage on the data storage drive of one or more of the plurality of mesh storage devices and cause the retrieved second data file to be transmitted over the local area network to the user device.

In other example implementations, a method is disclosed for providing distributed storage on a wireless local area network formed by a plurality of peer mesh storage devices simultaneously wirelessly connected together. Each of the plurality of peer mesh storage devices includes a computing processor, a communication transceiver, and a data storage drive. The method includes receiving a first data file from a user device connected to the local area network at one of a plurality of peer mesh storage devices; storing the first data file on the data storage drive of one or more of the plurality of mesh storage devices; retrieving a second data file requested by the user device from storage on the data storage drive of one or more of the plurality of mesh storage devices; and transmitting the retrieved second data file over the local area network to the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of various implementations of the present disclosure is provided in the following written description and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements. The proportions and dimensions of the various features and elements (and collections and groupings thereof) and the boundaries, separations, and positional relationships presented therebetween, are provided in the accompanying figures to facilitate an understanding of the various embodiments described herein and, accordingly, may not be presented or illustrated to scale, and are not intended to indicate any preference or requirement for an illustrated implementation to the exclusion of other implementations described with reference thereto.

The features, aspects, advantages, functions, modules, and components of the devices, systems and processes provided by the various implementations of the present disclosure are further disclosed herein regarding at least one of the following descriptions and accompanying drawing figures. In the appended figures, similar components or elements of the same type may have the same reference number and may include an additional alphabetic designator, such as 108a-108n, and the like, wherein the alphabetic designator indicates that the components bearing the same reference number, e.g., 108, share common properties and/or characteristics. Further, various views of a component may be distinguished by a first reference label followed by a dash and a second reference label, wherein the second reference label is used for purposes of this description to designate a view of the component. When the first reference label is used in the specification, the description is applicable to any of the similar components and/or views having the same first reference number irrespective of any additional alphabetic designators or second reference labels, if any.

FIG. 1 is a schematic illustration of an example implementation of a wireless mesh local area network.

FIG. 2 is a schematic illustration of an example implementation of a wireless mesh storage network.

FIG. 3 is a schematic diagram of an example mesh storage device capable of implementing processes for providing wireless mesh storage on a local area network.

FIG. 4 is a flow diagram of an example process implemented for providing functionality within a wireless mesh storage network.

FIG. 5 is a flow diagram of another example process implemented for providing functionality within a wireless mesh storage network.

FIGS. 6A-6C are together a schematic illustration of an example implementation of a control application for a mesh storage network configured for a mobile computing device.

FIGS. 7A-7C are together a schematic illustration of an example implementation of a photo storage module of the control application of FIGS. 6A-6C for storing digital photographs on the mesh storage network.

FIGS. 8A-8C are together a schematic illustration of an example implementation of a video playback module of the control application of FIGS. 6A-6C for playing a video file stored on a mesh storage network.

FIGS. 9A-9B are together a schematic illustration of an example implementation of a computing device backup module of the control application of FIGS. 6A-6C.

### DETAILED DESCRIPTION

“Additional I/O interface” (AIOI) herein refers to one or more components, provided with or coupled to a device, configured to support a receiving and/or presenting of additional inputs and outputs to and from one or more users. An AIOI may be configured to support the receiving and presenting of the additional I/O content (AIO) to users. Herein, the AIO, as communicated, may be referred to as “AIO signals.” An AIO signal may include an audible signal or a visible signal and may be communicated separately or collectively therewith. An AIOI may include any interface not otherwise categorized as an Audio I/O interface or a Visual I/O interface with non-limiting examples including touch pads, keyboards, sensors, motion detectors, tactile elements, and the like. Any known or later arising technologies configured to convey information to or from one or more users as an AIO signal may be utilized for at least one implementation of the present disclosure. An AIOI includes hardware and computer instructions (herein, “AIO technologies”) which supports the input and output of other signals with a user.

“Audio I/O interface” herein refers to one or more components, provided with or coupled to an electronic device, configured to support a receiving and/or presenting of humanly perceptible audible content to one or more users. Such audible content (which is also referred to herein as being “audible signals”) may include spoken text, sounds, or any other audible information. Such audible signals may include one or more humanly perceptible audio signals, where humanly perceptible audio signals typically arise between 20 Hz and 20 KHz. The range of humanly perceptible audio signals may be configurable to support an audible range of a given individual user. An audio I/O interface includes hardware and computer instructions (herein, “audio technologies”) which supports the input and output of audible signals to a user. Such audio technologies may include, but are not limited to, noise cancelling, noise reduction, technologies for converting human speech to text, text to speech, translation from a first language to one or more second languages, playback rate adjustment, playback frequency adjustment, volume adjustments and otherwise. An audio I/O interface may use one or more microphones and speakers to capture and present audible signals respectively from and to a user. Such one or more microphones and speakers may be provided by a given device itself or by a device communicatively couple additional audible device component. For example, earbuds may be communicatively coupled to a smartphone, with the earbuds functioning as an audio I/O interface and capturing and presenting audio signals as sound waves to and from a user, while the smartphone functions as a UD. An audio I/O interface may be configured to automatically recognize, and capture comments spoken by a user and intended as audible signals for sharing with other users, inputting commands, or otherwise.

“Application” herein refers to a set of computer instructions that configure one or more processors to perform one or more tasks that are other than tasks commonly associated with the operation of the processor itself (e.g., a “system software,” an example being an operating system software), or the providing of one or more utilities provided by a device (e.g., a “utility software,” an example being a print utility). An application may be bundled with a given device or published separately. Non-limiting examples of applications include word processing applications (e.g., Microsoft WORD™), video streaming applications (e.g., SLINGTV™), video conferencing applications (e.g., ZOOM™), gaming applications (e.g., FORTNITE™), and the like.

“Bus” herein refers to any known and/or later arising technologies which facilitate the transfer of data within and/or between devices. Non-limiting examples include Universal Serial Bus (USB), PCI-Express, Compute Express Link (CXL), IEEE-488 bus, High Performance Parallel Interface (HIPPI), and the like.

“Cloud” herein refers to cloud computing, cloud storage, cloud communications, and/or other technology resources which a given user does not actively manage or provide. A usage of a Cloud resource may be private (limited to various users and/or uses), public (available for multiple users and/or uses), hybrid, dedicated, non-dedicated, or otherwise. It is to be appreciated that implementations of the present disclosure may use Cloud resources to provide for processing, storage and other functions related to facilitating SGPs. An implementation may utilize Cloud resources using any known or later arising data delivery, processing, storage, virtualization, or otherwise technologies, standards, protocols (e.g., the Simple Object Access Protocol (SOAP), the Hyper Text Transfer Protocol (HTTP), Representational State Transfer protocol (REST), or the like. Non-limiting examples of such technologies include Software as a Service (SaaS), Platform as a Service (Paas), Infrastructure as a Service (laas), and the like. Cloud resources may be provided by one or more entities, such as AMAZON WEB SERVICES provided by Amazom.com Inc., AZURE provided by Microsoft Corp., and others.

“Computer engine” (or “engine”) herein refers to a combination of a processor and computer instruction(s). A computer engine executes computer instructions to perform one or more logical operations (herein, a “logic”) which facilitate various actual (non-logical) and tangible features and function provided by a system, a device, and/or combinations thereof.

“Content” herein refers to data that that may be presented, using a suitable presentation device, to a user in a humanly perceptible format. When presented to a human, the data becomes “information.” Non-limiting examples of content include gaming images and graphics such as those related to bet placement, or otherwise. Content may include, for example and not by limitation, one or more sounds, images, video, graphics, gestures, or otherwise. The content may originate from any source, including live and/or recorded, augmented reality, virtual reality, computer generated, or otherwise. The content may be presented to a given user using any user device and any user interface. Content may be stored, processed, communicated, or otherwise utilized.

“Coupling” herein refers to the establishment of a communications link between two or more elements of a given system. A coupling may utilize any known and/or later arising communications and/or networking technologies, standards, protocols or otherwise. Non-limiting examples of such technologies include packet switch and circuit switched communications technologies, with non-limiting examples including, Wide Area Networks (WAN), such as the Internet, Local Area Networks (LAN), Public Switched Telephone Networks (PSTN), Plain Old Telephone Service (POTS), cellular communications networks such as a 3G/4G/5G or other cellular network, IoT networks, Cloud based networks, private networks, public networks, or otherwise. One or more communications and networking standards and/or protocols may be used, with non-limiting examples including, the TCP/IP suite of protocols, ATM (Asynchronous Transfer Mode), the Extensible Message and Presence Protocol (XMPP), Voice Over IP (VOIP), Ethernet, Wi-Fi, CDMA, Z-WAVE, Near Field Communications (NFC), GSM/GRPS, TDMA/EDGE, EV/DO, WiMAX, SDR, LTE, MPEG, BLUETOOTH, and others. A coupling may include use of physical data processing and communication components. A coupling may be physically and/or virtually instantiated. Non-limiting examples of physical network components include data processing and communications components including computer servers, blade servers, switches, routers, encryption components, decryption components, and other data security components, data storage and warehousing components, and otherwise. Any known or later arising physical and/or virtual data processing and/or communications components may be utilized for a given coupling.

“Data” (which is also referred to herein as a “computer data”) herein refers to any representation of facts, information or concepts in a form suitable for processing, storage, communication, or the like by one or more electronic device processors, data stores, routers, gateways, or other data processing and/or communications devices and systems. Data, while and/or upon being processed, may cause or result in an electronic device or other device to perform at least one function, task, operation, provide a result, or otherwise. Data may be communicated, processed, stored and/or otherwise exist in a transient and/or non-transient form, as determined by any given state of such data, at any given time. For a non-limiting example, a given data packet may be non-transient while stored in a storage device, but transient during communication of the given data packet from a first device or system to a second (or more) device or system. When received and stored in memory, data storage device, or otherwise, the given data packet has a non-transient state. For example, and not by limitation, data may take any form including as one or more applications, content, or otherwise. Instructions, as further described herein, are a form of data.

“Data store” herein refers to any device or combinations of devices configured to store data on a temporary, permanent, non-transient, or other basis. A data store is also referred to herein as a “computer readable medium.” A data store may store data in any form, such as electrically, magnetically, physically, optically, or otherwise. A data store may include a memory devices, with non-limiting examples including random access memory (RAM) and read only memory (ROM) devices. A data store may include one more storage devices, with non-limiting examples including electrical storage drives such as EEPROMs, Flash drives, Compact Flash (CF), Secure Digital (SD) cards, Universal Serial Bus (USB) cards, and solid-state drives, optical storage drives such as DVDs and CDs, magnetic storage drives such as hard drive discs, magnetic drives, magnetic tapes, memory cards, and others. Any known or later arising memory and data storage device technologies may be utilized for a given data store. Available storage provided by a given one or more data stores may be partitioned or otherwise designated by the storage controller as providing for permanent storage and temporary storage. Non-transient data, computer instructions, or other the like may be suitably stored in a data store. As used herein, permanent storage is distinguished from temporary storage, with the latter providing a location for temporarily storing data, variables, or other instructions used for a then arising or soon to arise data processing operations. A non-limiting example of a temporary storage is a memory component provided with and/or embedded onto a processor or integrated circuit provided therewith for use in performing then arising data calculations and operations. Accordingly, it is to be appreciated that a reference herein to “temporary storage” is not to be interpreted as being a reference to transient storage of data. Permanent storage and/or temporary storage may be used to store transient and non-transient data with the data, while stored, being herein deemed to be non-transient data.

“Device” and “electronic device” herein refer to any known or later arising electrical device configured to, singularly and/or in combination, communicate, manipulate, output for presentation as information to a human, process, store, or otherwise utilize data. Non-limiting examples of devices include user devices and servers.

“Instruction” (which is also referred to herein as a “computer instruction”) herein refers to a non-transient processor executable instruction, associated data structures, sequence of operations, program modules, or the like. An instruction is described by an instruction set. It is commonly appreciated that instruction sets are often processor specific and accordingly an instruction may be executed by a processor in an assembly language or machine language format that is translated from a higher level programming language. An instruction may be provided using any form of known or later arising programming; non-limiting examples including declarative programming, imperative programming, functional programming, procedural programming, stack based programming, object-oriented programming, and otherwise. An instruction may be performed by using data and/or content stored in a data store on a transient and/or non-transient basis, as may arise for any given data, content and/or instruction.

“Module” herein refers to and, when claimed, recites definite structure for an electrical/electronic device that is configured to provide at least one feature and/or output signal and/or perform at least one function including the features, output signals and functions described herein. A module may provide the one or more functions using computer engines, processors, computer instructions and the like. When a feature, output signal and/or function is provided, in whole or in part, using a processor, one more software components may be used, and a given module may include a processor configured to execute computer instructions. A person of ordinary skill in the art (a “POSITA”) will appreciate that the specific hardware and/or computer instructions used for a given implementation will depend upon the functions to be accomplished by a given module. Likewise, a POSITA will appreciate that such computer instructions may be provided in firmware, as embedded software, provided in a remote and/or local data store, accessed from other sources on an as-needed basis, or otherwise. Any known or later arising technologies may be used to provide a given module and the features and functions supported therein.

“Power Supply/Power” herein refers to any known or later arising technologies which facilitate the use of electrical energy by a device. Non-limiting examples of such technologies include batteries, power converters, inductive charging components, line-power components, solar power components, and otherwise.

“Processor” herein refers to one or more known or later developed hardware processors and/or processor systems configured to execute one or more computer instructions, with respect to one or more instances of computer data, and perform one or more logical operations. The computer instructions may include instructions for executing one or more applications, software engines, and/or processes configured to perform computer executable operations. Such hardware and computer instructions may arise in any computing configuration including, but not limited to, local, remote, distributed, blade, virtual, or other configurations and/or system configurations. Non-limiting examples of processors include discrete analog and/or digital components that are integrated on a printed circuit board, as a system on a chip (SOC), or otherwise; Application specific integrated circuits (ASICs); field programmable gate array (FPGA) devices; digital signal processors; general purpose processors such as 32-bit and 64-bit central processing units; multi-core ARM based processors; microprocessors, microcontrollers; and the like. Processors may be implemented in single or parallel or other implementation structures, including distributed, Cloud based, and otherwise.

“Security Component/Security” herein refers to any known or later arising processor, computer instruction, and/or combination thereof configured to secure data as communicated, processed, stored, or otherwise manipulated. Non-limiting examples of security components include those implement encryption standards, such as an Advanced Encryption Standard (AES), and transport security standards, such as Transport Layer Security (TLS) or Secure Sockets Layer (SSL).

“Server” herein refers to one or more devices that include computer hardware and/or computer instructions that provide functionality to one or more other programs or devices (collectively, “clients”). Non-limiting examples of servers include database servers, file servers, application servers, web servers, communications servers, virtual servers, computing servers, and the like. Servers may be combined into clusters (e.g., a server farm), logically or geographically grouped, or otherwise. Any known or later arising technologies may be used for a server.

A server may instantiate one or more computer engines as one or more threads operating on a computing system having a multiple threaded operating system, such as the WINDOWS, LINUX, APPLE OS, ANDROID, and other operating systems, as an application program on a given device, as a web service, as a combination of the foregoing, or otherwise. An Application Program Interface (API) may be used to support an implementation of the present disclosure. A server may be provided in the virtual domain and/or in the physical domain. A server may be associated with a human user, a machine process executing on one or more computing devices, an API, a web service, instantiated on the Cloud, distributed across multiple computing devices, or otherwise. A server may be any electronic device configurable to communicate data using a network, directly or indirectly, to another device, to another server, or otherwise.

“Substantially simultaneous(ly)” herein refers to an absence of a greater than expected and humanly perceptible delay between a first event or condition, and a second event or condition. Substantial simultaneity may vary in a range of quickest to slowest expected delay, to a moderate delay, or to a longer delay.

“User Device” herein refers to a device configured for use by a human being to one or more of communicate, present, process, and store data. Non-limiting examples of user devices include smartphones, laptop computers, tablet computing devices, desktop computers, smart televisions, smart glasses, virtual reality glasses, augmented reality glasses, earbuds/headphones and other audible output devices, and other devices.

“User Interface” herein refers to one more components, provided with or coupled to a device configured to receive information from and/or present information to a user. A user interface may include one more Additional I/O interfaces, Audio I/O interfaces, and Visual I/O interfaces.

“Visual I/O interface” herein refers to one or more components, provided with or coupled to a device, configured to support a receiving and/or presenting of humanly perceptible visual content to one or more users. A visual I/O interface may be configured to support the receiving and presenting of visual content (which is also referred to herein as being “visible signals”) to users. Such visible signals may be in any form, such as still images, motion images, augmented reality images, virtual reality images, and otherwise. A visual I/O interface includes hardware and computer instructions (herein, “visible technologies”) which supports the input by and output of visible signals to users via a device. Such visible technologies may include technologies for converting images (in any spectrum range) into humanly perceptible images, converting content of visible images into a given user's perceptible content, such as by character recognition, translation, playback rate adjustment, playback frequency adjustment, and otherwise. A visual I/O interface may be configured to use one or more display devices, such as an internal display and/or external display for a given device with the display(s) being configured to present visible signals to a user. A visual I/O interface may be configured to use one or more image capture devices to capture content. Non-limiting examples of image capture devices include lenses, cameras, digital image capture and processing software, and the like. Accordingly, it is to be appreciated that any existing or future arising visual I/O interfaces, devices, systems and/or components may be utilized by and/or in conjunction with a device to facilitate the capture, communication and/or presentation of visible signals to a user.

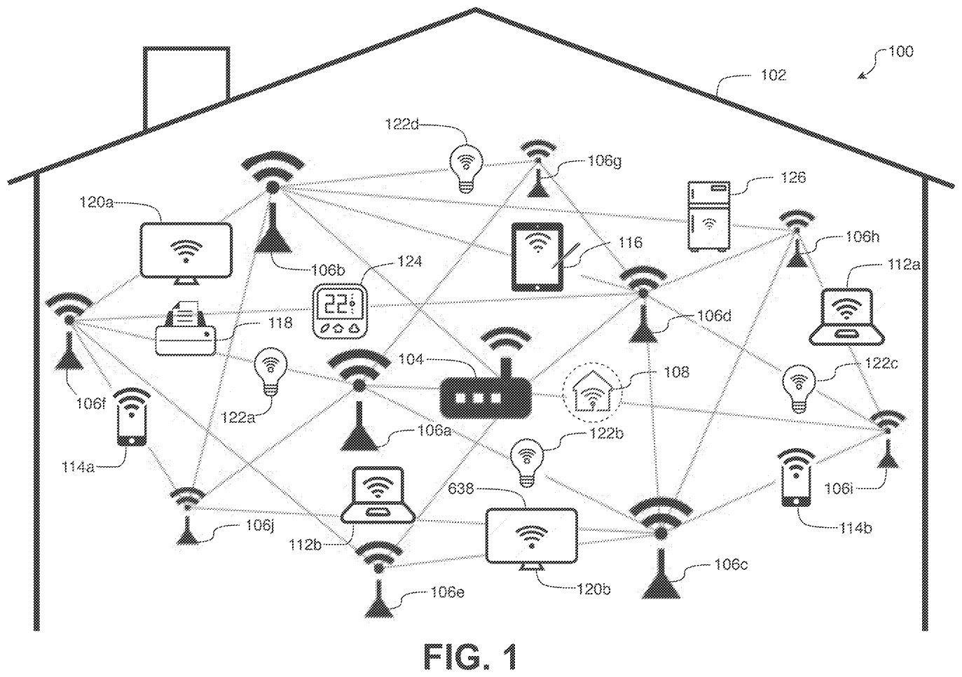

As shown in FIG. 1 and for at least one implementation of the present disclosure, a mesh local area network (a “mesh LAN”) 100 is depicted schematically in the context of a home 102. The mesh LAN 100 may be used in other context, such as in a business, for other implementations. A mesh LAN 100 is a network topology in which the infrastructure nodes (e.g., bridges, switches, and other infrastructure devices) connect directly, dynamically, and non-hierarchically to one or more other nodes of the mesh LAN 100 and cooperate with one another to route data to and from one or more devices on the mesh LAN 100 and to node external to the mesh LAN 100, such as one or more Internet servers or the like. A mesh LAN 100 does not include one or more central nodes, e.g., a central switch, router, or network access device, through which data between nodes on the mesh LAN 100 is communicated and thereby facilitates communication of data between nodes using one or more nodes on the mesh LAN 100.

For at least one implementation, nodes on the mesh LAN 100 may be configured to dynamically self-organize and self-configure. This typically provides for simple installation for users of new user devices onto the mesh LAN 100. The capability of the mesh LAN 100 to self-configure enables dynamic distribution of workloads, particularly if one of the nodes fails, providing a higher level of network fault tolerance.

The mesh LAN 100 in FIG. 1 may include a network access device 104 and a plurality of satellite node devices 106a-j. The satellite node devices 106 function as transceivers operating on a wireless network communication protocol (e.g., IEEE 802.11xx, WIFI® 4-7, or similar) and communicate data between user devices and the network access device 104 within the mesh LAN 100. (Note, in the context of the present disclosure, the use of the term satellite in conjunction with transceiver node devices is intended to connote the physical distribution of the node devices within a LAN and with respect to a related network access device.) The network access device 104 may include the functionality of the node devices 106a-j, and generally operates as a peer with respect to the node devices 106a-j in the context of transmitting information within the mesh LAN 100. The network access device 104 further provides router and modem functionality to manage user device requests and routing and connect the mesh LAN to an external network, e.g., the Internet, respectively. A mesh software application 108 may be instantiated by any user device connected to the mesh LAN 100 to configure and control various features of the network access device 104 and node devices 106a-j of the mesh LAN 100.

As depicted in FIG. 1, the mesh LAN 100 in the example home environment may connect any number of user devices. For example, personal computers 112a and 112b (laptop or desktop), smartphones 114a and 114b, and tablet computers 116 may connect to the mesh LAN 100. Peripheral devices such as printers 118, scanners, and wireless speakers can be connected to the mesh LAN 100 for access and use by the user devices. As shown, wireless equipped televisions 120a and 120b, cable television or satellite set-top boxes, Apple TV and other content streaming devices, may also be connected to the mesh LAN 100 to access the Internet and download or stream content for presentation on the televisions 120a-b or other presentation devices.

Additional devices for control of the environment of or appliances within the home 102 may also connect to the mesh LAN 100. For example, smart lightbulbs 122a. 122b, 122c and 122d or smart power outlets may be connected to the mesh LAN 100. A thermostat 124 for controlling HVAC equipment in the home 102, as well as similar control or monitoring devices such as solar panel monitoring systems, may also connect to the mesh LAN 100. Further, “smart” appliances such as a refrigerator 126 or other Internet-of-things (IoT) devices equipped with WIFI® or Bluetooth® transceivers may also connect with the wireless mesh LAN 100. The devices connected to the mesh LAN 100 may be controlled by a user device through a mesh software application 108 or another software application specifically designed for the control of such devices or appliances.

Contrast the communication capabilities of a mesh LAN 100 with providing accessible storage across a LAN. Local storage is cumbersome to manage-hard drives in different computing devices connected to the LAN do not easily communicate with other storage devices unless the computing devices have been specially and specifically configured to do so. Such communication is typically platform and operating system specific-Apple operating system devices will not connect with Microsoft Windows operating system devices to share access to memory-absent specialized software installed on a computing device and specifically configured to allow for mutual hard drive storage access. Comparatively, Cloud storage is a much simpler solution-a user merely creates a storage account, downloads a software application to a computing device, and data files are automatically uploaded to and downloaded from the cloud by the software application.

Another option for local storage on a LAN is a network-attached storage (NAS) device. A NAS device is a specialized file-level computer data storage server connected to a computer network providing data access to client device connected to the LAN. NAS devices contain one or more removable storage drives, often arranged into logical, redundant storage containers, also referred to as a “redundant array of independent disks” (RAID). NAS devices typically provide access to files using network file sharing protocols. NAS devices are a significant investment for use in a home or small business LAN-purchase of the removable storage disks is separate from acquisition of the base NAS appliance. Additionally, configuration of the NAS device on the LAN typically requires appreciable computer networking knowledge. Additionally, as NAS devices use network file sharing protocols, they are designed for use with desktop/laptop operating systems and corresponding file structures and do not easily interface with file structures of mobile devices such as smartphones and tablet computers which may regularly connect with the LAN in a home or small business.

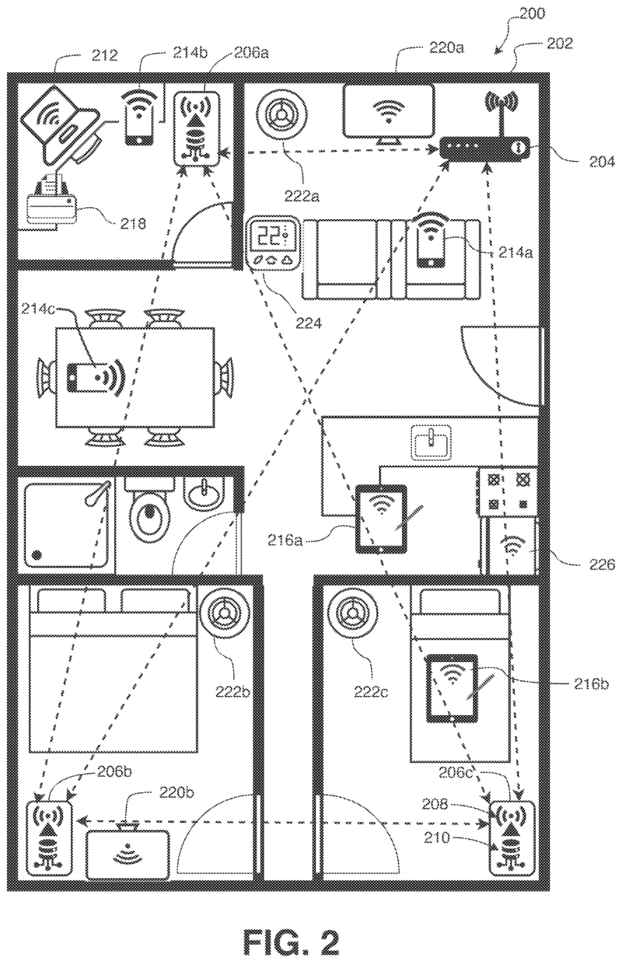

An alternative data storage solution for a LAN environment is a mesh storage network 200 disclosed herein and schematically depicted in FIG. 2. The mesh storage network 200 is presented in the context of the home 202 in FIG. 2 but can be implemented in generally any indoor and/or outdoor space. The mesh storage network 200 leverages the topology, efficiency, and redundancy of a mesh LAN in its provision of satellite mesh storage devices 206a-c, which include a wireless transceiver 208 as well as a data storage drive 210. (Note, in the context of the present disclosure, the use of the term satellite in conjunction with mesh storage devices is intended to connote the physical distribution of the mesh storage devices devices within the LAN and with respect to a related network access device). The wireless transceivers 208 provide the typical peer-to-peer LAN communication functionality of wireless mesh node devices. In example implementations, the data storage drive 210 in a mesh storage device 206 can be a solid-state drive (e.g., based upon flash memory). The data storage drive 210 can be a magnetic hard disk drive. For at least one implementation, the data storage drives 210 may have any desired storage capacity, for example, 250 GB, 500 GB, 1 TB, etc.

The mesh storage network 200 provides the same wireless LAN functionality as the typical mesh wireless network of FIG. 1 via the wireless transceivers 208 in each of the mesh storage devices 206a-c. The mesh storage devices 206a-c may further support Bluetooth® and other near field communication (NFC) connectivity for case of interaction with various user devices (e.g., wireless loudspeakers, smart watches, etc.). The mesh storage devices 206a-c can be deployed and configured using the same constructs as present network management applications for wireless mesh networks. The mesh storage devices 206a-c may be configured to receive and store data internally as well as distribute data to and retrieve data from any peer mesh storage device 206a-c on the mesh storage network. Just as data communications between and among the mesh storage devices 206a-c is seamless and redundant, the data transfer for storage in the data storage drives 210 on the mesh storage devices 206a-c can be easily managed through straightforward software applications through any user device connected to the mesh storage network 200.

As depicted in the home 202 in FIG. 2, a large number of user devices, control systems, and appliances can be connected to the mesh storage network 200 and access for control, management, and data reporting. For example, the home 202 may include a main living area in which a mesh storage device in the form of a network access device 204 is located. The network access device 204 is typically located in close proximity to a wired connection to a wide area network (a “WAN”), e.g., a coaxial cable connected to a cable television network providing Internet access, a fiber optic communication network, or a twisted pair wire telephone jack connected to a telephony network offering digital subscriber line (DSL) service.

In the example of FIG. 2, several devices may be located within or adjacent to the main living area and communicate wirelessly on the mesh storage network 200 primarily by connection through the network access device 204. These example devices include a television 220a, a thermostat 224, a light fixture with a smart bulb 222a, a smartphone 214a, and other forms of devices. The network access device 204 may also be the primary LAN connection for a tablet computer 216a being used in the kitchen, as well as providing connectivity for the refrigerator 226 with IOT connectivity. The network access device 204 may further provide connectivity to the mesh storage network 200 for a smartphone 214c being used in the dining room.

A first mesh storage device 206a on the mesh storage network 200 may be positioned in an office area to provide improved connectivity for devices in the office such as a personal computer 212, a smartphone 214b and a wireless printer 218. A second mesh storage device 206b may be positioned in a first bedroom to provide improved connectivity for devices in the first bedroom such as a television 220b and a light fixture with a smart bulb 222b. A third mesh storage device 206c may be positioned in a second bedroom to provide improved connectivity for devices in the second bedroom such as a tablet computer 216b and another light fixture with a smart bulb 222c.

As noted above, the mesh storage devices 206a-c, as well as the network access device 204, may be redundant for purposes of providing communication for any device connected to the mesh storage network 200. Therefore, if there is interference between the first mesh storage device 206a and the tablet computer 216a in the kitchen, e.g., due to shielding by a large metal object placed on the counter, the tablet computer 216a may seamlessly connect with the third mesh storage device 206c in the second bedroom to provide network connectivity. If the third mesh storage device 206c is similarly blocked from direct communication with the network access device 204, for example, to connect the tablet computer 216a to the Internet, the third mesh storage device 206c can route the communication traffic to the second mesh storage device 206b in the first bedroom, which can similarly attempt to connect to the network access device 204. If direct communication between the second mesh storage device 206b and the network access device 204 is similarly blocked, the second mesh storage device can route communications from the tablet computer 216a in the kitchen to the first mesh storage device 206a in the office and then to the network access device 204. Any other combination or routing of communication traffic between any of the mesh storage devices 206a-c and the network access device 204 is possible within the mesh storage network 200.

Similarly, data sought to be stored by any user device connected to the mesh storage network 200 can therefore be stored on any of the mesh storage devices 206a-c, as well as on the network access device 204 if it is similarly equipped with a data storage drive to function as another storage node of the mesh storage network 200. The mesh storage network 200 takes advantage of the mesh wireless communication architecture to transmit data between and among any of the mesh storage devices 206a-c for storage, thus functioning as a localized cloud storage network. The mesh storage network 200 thereby provides a simple system for local data storage accessible by any user device, with appropriate access authorization, connected to the mesh storage network 200.

Data files can be stored and shared securely on a local Cloud within the LAN, without need for an Internet connection, and without need to transmit data over the Internet for storage and management by third party data servers. This may be advantageous for storage of sensitive data that a user would prefer to maintain under local control and reduce the risk of being subject to a data breach within a large, external storage platform, which is a much more likely target for sophisticated hacking than a personal, home computer network. Additionally, with appropriate configuration, knowledge of the IP address of the network access device 204, and access credentials, data files could be accessed from the mesh storage network 200 remotely over an Internet connection.

The mesh storage network 200 also provides an opportunity for additional levels of local data encryption. Because each mesh storage device 206 includes a separate data storage drive 210, a data file may be partitioned, and pieces of the data file may be stored separately on each of the mesh storage devices 206 within the mesh storage network 200. In one example implementation, the mesh storage network 200 may be configured to require the mesh storage devices 206 (and the network access device 204) registered with the mesh storage network 200 be connected and active on the mesh storage network 200 as a verification factor to store, access, and retrieve data. In this way, theft or hacking of one or several, but not all, of the mesh storage devices 206a-c registered on the mesh storage network 200 would effectively prevent access to or retrieval of the stored data. Even though, as is typical of the architecture, the mesh storage network 200 can still function and provide LAN communication in the absence of a registered mesh storage device 206a-c, such absence could also indicate a network problem or fault for investigation and correction, which would need to be resolved for access and retrieval of data files stored in an encryption configuration.

In an alternative example configuration, the mesh storage network 200 may provide for redundancy of data storage by storing multiple copies of a data file among two or more of the mesh storage devices 206a-c. Such functionality can be provided in parallel with the distributed encryption functionality; i.e., some sensitive data files can be designated for encrypted storage, while other data files can be designated for non-encrypted storage wherein redundant storage among several of the mesh storage devices 206a-c is implemented.

In another example implementation, the mesh storage network 200 can be configured to provide intelligent load balancing. For example, if a data write of a large first data file from a first user device is being performed on a first one of the mesh storage devices 206, and a second user device requests storage of a second data file, the second request for data storage may be routed to and performed at a second one of the mesh storage devices 206, even if the second user device is physically closer to first mesh storage device 206a, to avoid slowing down the data write process already in progress on the first mesh storage device 206a. Similarly, if the mesh storage network 200 is configured for redundant storage among the mesh storage devices 206a-c, user devices simultaneously requesting data may be routed to different ones of the mesh storage devices 206a-c for data retrieval. This can be especially advantageous when multiple devices request large files over an extended period of time, e.g., when streaming stored video files. By balancing the data transfer load across the mesh storage network 200, speed and efficiency of storage and retrieval of data files is improved for all users.

Another advantage of the mesh storage network 200 is expandability. If the storage capacity of the mesh storage network 200 is running low, an additional mesh storage device 206 can be purchased and easily added to and registered on the mesh storage network 200. Additionally, the mesh storage network 200 can be configured to self-monitor the health and lifespan of each of the mesh storage devices 206a-c on the mesh storage network 200. For example, solid state drive (SSD) storage devices generally have a calculable life span, typically based upon the number of write cycles performed on the SSD device. For mesh storage devices 206a-c incorporating SSD devices as the data storage drive 210, the write cycles can be counted and compared to the end-of-life specification for the SSD device model and the user can be warned to replace the device, e.g., the first mesh storage device 206a, before it fails. In addition, the mesh storage network 200 can proactively offload and copy data from the close to end-of-life data storage drive 210 in the first mesh storage device 206a to other the other devices, e.g., to the second mesh storage device 206b, within the mesh storage network 200 to avoid any data loss if the data storage drive 210 in the first mesh storage device 206a fail before the user replaces it with a new one. While this example is in the context of SSD devices, the mesh storage network 200 can be configured to run diagnostic tests on hard disk drives (HDD) or other forms of storage that may be used as data storage drives 210 within the mesh storage devices 206a-c to similarly warn users of problems, recommend replacement, and offload data to peer mesh storage devices 206a-c before failure.

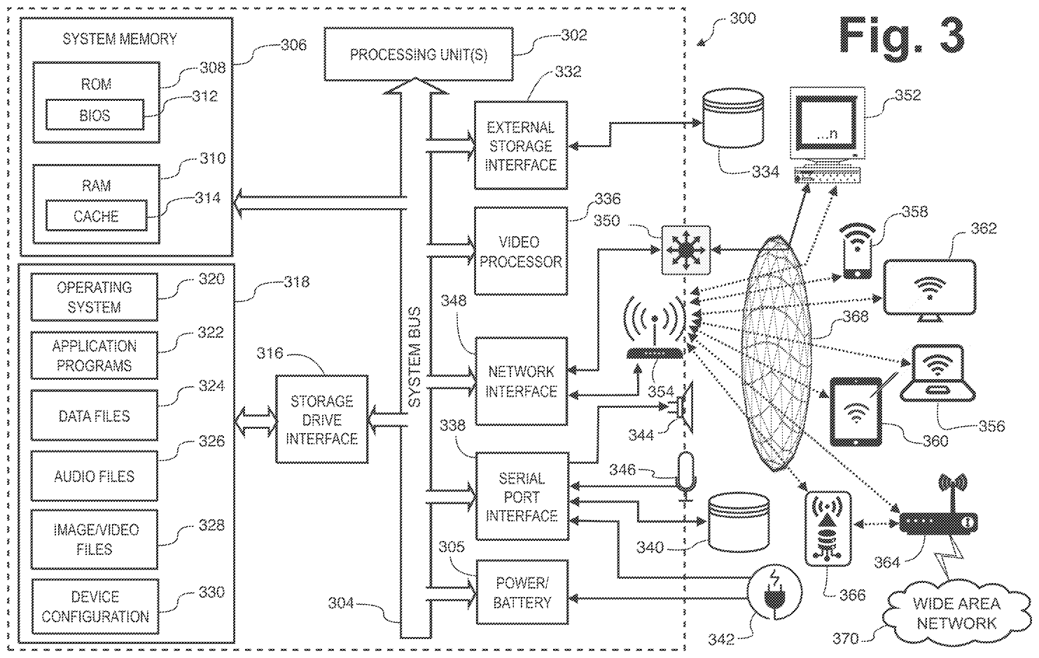

A mesh storage device 300 for implementing a local area, mesh storage network 200 as described above is depicted in FIG. 3. The mesh storage device 300 may be special purpose computer device with internal processing and memory components as well as interface components for connection with external input, output, storage, network, and other types of peripheral devices, particularly configured to perform the functions described herein. Internal components of the mesh storage device 300 in FIG. 3 are shown within the dashed line and external components are shown outside of the dashed line. Components that may provide an interface between internal and external components are shown straddling the dashed line.

In any embodiment described herein, the mesh storage device 300 includes a processor 302 and a system memory 306 connected by a system bus 304 that also operatively couples various system components. There may be one or more processors 302, e.g., a single central processing unit (CPU), or a plurality of processing units, commonly referred to as a parallel processing environment (for example, a dual-core, quad-core, or other multi-core processing device). The system bus 304 may be any of several types of bus structures including a memory bus or memory controller, a peripheral bus, a switched-fabric, point-to-point connection, and a local bus using any of a variety of bus architectures. The mesh storage device 300 may include a power source 305, e.g., either or both an electrical port for connecting to an AC/DC inverter 342 for constant power or an internal battery charged by the AC/DC inverter 342 for working without a connected power source or for provision of backup power in a case of general or local power outage or emergency.

The system memory 306 includes read only memory (ROM) 308 and random access memory (RAM) 310. A basic input/output system (BIOS) 312, containing the basic routines that help to transfer information between elements within the mesh storage device 300, such as during start-up, is stored in ROM 308. A cache 314 may be set aside in RAM 310 to provide a high-speed memory store for frequently accessed data or for managing data transfers.

A storage drive interface 316 may be connected with the system bus 304 to provide read and write access to a data storage drive 318, e.g., a solid-state drive or a magnetic hard disk drive for nonvolatile storage of applications, files, and data. A number of program modules and other data may be stored on the data storage drive 318, including an operating system 320, one or more application programs 322. In particular, application programs 322 may manage the storage functionality of the mesh storage device 300 in cooperation with instruction received from a cooperative application on a user device, such as a laptop computer 356, desktop computer 352, or mobile device such as a smartphone 358. The data storage drive 318 may store any of a variety of data files 324 from devices wirelessly connected to the mesh storage device 300. The data storage drive may provide storage for audio files 326, image (photographs) and video files 328, and device configuration files 330, e.g., for computing devices backed-up to one or more of the mesh storage devices within the local network.

In some configurations, an additional external storage capacity may be connected to the mesh storage device 300. For example, one or more external storage drives 334 may be connected with the system bus 304 via an external storage interface 332 to provide read and write access to the external storage drive 334 initiated by other components or applications within the mesh storage device 300. In some embodiments, external storage drives 340 may also be connected to the system bus 304 via a serial port interface 338 leveraging the data transfer capabilities of serial port interface protocols such as universal serial bus (USB) or IEEE 1394 interface (“Firewire”) standards. Exemplary external storage drives 334, 340 may include solid state memory drives (e.g., “Flash” memory drives), a magnetic disk drive for reading from or writing to an internal magnetic platter or a removable magnetic disk, tape, or other magnetic media, and/or an optical disk drive for reading from or writing to a removable optical disk such as a CD-ROM, a DVD, or other optical media. The external storage drives 334, 340, and any associated removable computer-readable media, may be used to provide nonvolatile storage of computer-readable instructions, data structures, program modules, video, audio, and other data transferred to the mesh storage device 300.

In some implementations, the serial port interface 338 may provide an additional or alternative mechanism for connecting to the AC/DC inverter 342 to receive power for the mesh storage device 300. The mesh storage device 300 may further incorporate a loudspeaker 344 and a microphone 346, for example, connected through the serial port interface 338. The microphone 346 may be voice sensitive and allow for control of various features of the mesh storage device 300 by voice command. The loudspeaker 344 may be used by the mesh storage device 300 to provide audible operational or configuration instructions to a user or provide audible content to a user, for example, by streaming music from remote source over the Internet or playing music files locally stored on the mesh storage device 300 or stored on another mesh storage node on the network.

The mesh storage device 300 may also include a video processor 336 and/or a graphics card to aid in processing a video file 328 for storage or for streaming of presentation on a presentation device connected to the wireless mesh LAN, e.g., a television 362, a smartphone 358, a tablet computing device 360, or other device with a display screen. Depending upon the type of presentation device, the video processor 336 can output a different quality streaming video file to the presentation device. For example, if a smartphone 358 requests a video file 328, the mesh storage device 300 can direct the video processor 336 to downscale the stored video file 328 to a resolution appropriate for playback on the small screen of the smartphone 358. This also reduces the data traffic on the mesh LAN and increases efficiency and throughput. If a high definition (HD) television 362 is the presentation device requesting a stored video file 328, the video processor 336 can output a high quality, high resolution (e.g., 1080p or 4Kp, as appropriate) video data stream for playback on the television 362.

As discussed above, the mesh storage device 300 operates in a networked environment using logical connections through a network interface 348 coupled with the system bus 304 to communicate through wireless transmissions and communication protocols with one or more separate computing devices or presentation The logical connections depicted in FIG. 3 include a local-area network (LAN) 368 and a wide-area network (WAN) 370. Such networking environments are commonplace in home networks, office networks, enterprise-wide computer networks, and intranets. These logical connections may be achieved by a wired switch device 350, a wireless transceiver 354, and a network access device 364 coupled to or integral with the mesh storage device 300. In some implementations the mesh storage device 300 may function as a switch device 350 and include physical switch ports, for example, Ethernet ports, for directly connecting other network devices to the mesh storage device 300 and provide network switching functionality. In other embodiments, the mesh storage device 300 may include one or more Ethernet ports for wired connection with a switch device 350. The switch device 350 may be connected to other computing devices on the LAN 368.

The wireless transceiver 354 provides a wireless connection with the LAN 368, e.g., through one or more of the IEEE 302.11 family of protocols, including for WIFI® and 5G networks, or via Bluetooth® or other near field communication (NFC) protocols. The wireless transceiver 354 wirelessly transmits and receives data to and from user devices connected to the LAN 368, for example, a desktop computer 352, a laptop computer 356, a smartphone 358, a tablet computing device 360, and a television 362 or other presentation device incorporating a WIFI® chip or otherwise connectable to the LAN 368. The wireless transceiver 354 further connects the mesh storage device 300 to one or more additional mesh storage devices 366 on the LAN 368 to piggyback and forward signal transmissions to create a mesh network within the LAN 368 and/or distribute data for storage across the additional mesh storage devices 366 on the LAN 368.

The wireless transceiver 354 also wirelessly connects to the network access device 364. In some example implementations, the network access device 364 is one of the additional mesh storage devices 366 with additional components and functionality. As depicted in FIG. 3, the network access device 364 may operate as both a wireless router for directing traffic on the LAN 368 or may connect (not shown) with the switch device 350, either directly wired or wirelessly. To connect the mesh storage device 300 with a WAN 370, the network access device 364 typically includes a modem for establishing communications over the WAN 370 or other communication network. In some embodiments, the modem for external network connections and the router for local network connections may be separate components. For at least one implementation, the WAN 370 may be the Internet. In at least one implementation, the WAN 370 may be a large private network spread among multiple locations, or a virtual private network (VPN). The modem component of the network access device 364 may be a cable modem, a high-speed modem (e.g., a digital subscriber line (DSL) modem), a wireless telephone modem (e.g., for connecting with a 5G telephony network), or similar type of communications device. The network connections shown are exemplary and other means of, and communications devices for, establishing a network communications link between the mesh storage device 300 and other devices or networks may be used.

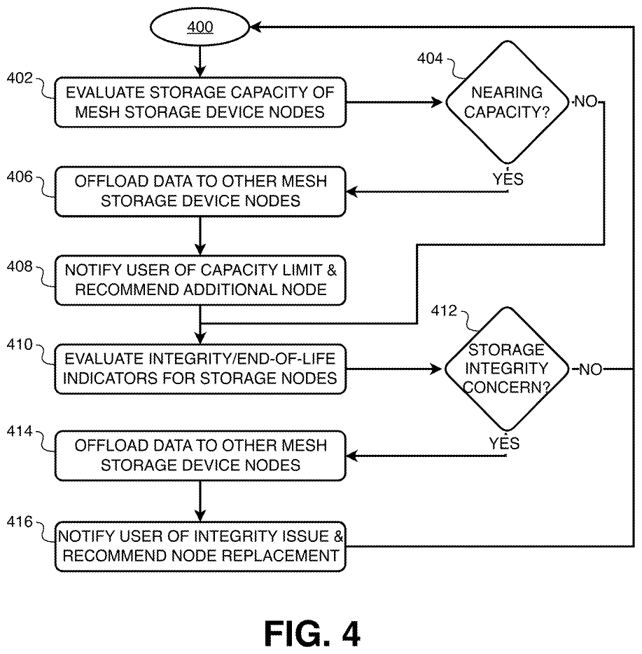

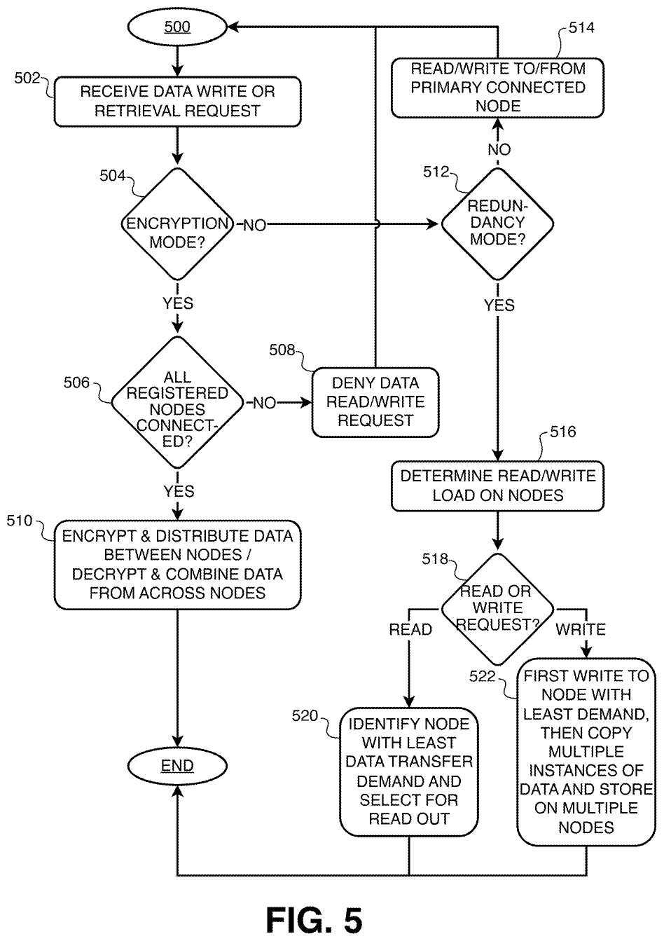

FIG. 4 depicts a method 400 for implementing various data storage functions made possible by the construct of a mesh storage network. In particular, the method 400 provides assurance that the mesh storage network capacity is adequate and functioning appropriately. The mesh storage network may be configured to regularly run diagnostic tests on the mesh storage devices connected to the mesh storage network. In the example method 400, a first evaluation operation 402 may be initially performed to measure remaining storage capacity in each of the mesh storage devices. In a first query operation 404 a determination is made as to whether each of the mesh storage devices has adequate storage capacity or whether it is nearing a storage limit. If a particular mesh storage device is nearing its storage capacity, the method 400 continues to a first offloading operation 406 wherein data from the nearly full mesh storage device is offloaded and transferred to other mesh storage devices on the network that have additional storage capacity to avoid write errors to a node with an at-capacity mesh storage device. In a further first notifying operation 408 a user or administrator of the mesh storage network can be alerted, e.g., through a management application on a user device, that a mesh storage device at a particular node, or that total storage across the mesh storage network, is near a capacity limit and that an additional mesh storage device may be added to the network to increase overall storage capacity. The management application may provide further options for reducing the data storage burden, for example, by turning off redundant or encrypted-distributed storage features as further described with respect to FIG. 5.

After the capacity check of the first query operation 404, in either a case of no capacity concern or after a notice of an approaching capacity limit is provided, the method 400 may continue to a second evaluation operation 410 in which each mesh storage device is interrogated with diagnostic tools to evaluate operational integrity of and/or end-of-life indicators for the data storage drive included therein. For example, SSD storage devices are rated for a given number of write cycles before there is a likelihood that the will fail to function. Additionally, for HDD storage devices, diagnostic tests can me run to determine whether the disks are spinning properly, and that data writes and reads are accurate. In a second query operation 412, if a storage integrity concern is determined, the method 400 continues to a second offloading operation 414 wherein data from the compromised or close to end of life mesh storage device is offloaded and transferred to other mesh storage devices on the network that are functioning properly or are within nominal life spans to ensure data integrity. In a second notifying operation 416 a user or administrator of the mesh storage network can be alerted, e.g., through a management application on a user device, that a mesh storage device at a particular node is potentially failing and recommend that it be replaced within the network by a new mesh storage.

FIG. 5 depicts a method 500 for implementing alternate data storage functions made possible by the construct of a mesh storage network. In an initial receiving operation 502, the method 500 receives a data storage or retrieval request from a user device on the wireless mesh network. In a first query operation 504, the method 500 determines whether the network as a whole, or with respect to requests from a particular user device connected to the network, has been configured in an encryption mode to encrypt data writes or retrieve and decrypt data stored within the mesh storage network. If the request is subject to the encryption mode, the method 500 first determines in a second query operation 506 whether all mesh storage devices registered on the network are, in fact, presently connected to the network. Requiring such a connection of all mesh storage device nodes provides a first level of security. Further, in the context of a retrieval request, a missing node would prevent any ability for accurate data retrieval as further described below.

If all registered mesh storage devices are not connected to the network, then in a denying operation 508 the data read or write request from the user device is denied and the method 500 resets to wait for the next read or write request. The method 500 may further provide notice to a user or administrator, e.g., through an application on a user device, that the request was denied as well as advice that a mesh device is missing from or not connected to the network. Reestablishment of a connection with the missing mesh storage device would be necessary to perform the read write request. In an example implementation, administrative override credentials could be used to complete a write request, but a read request might not be possible to fulfill.

If all registered mesh storage devices are determined to be connected to the network, then in an encrypting/decrypting operation 510 is performed. In particular, if a data storage request is received from a user device, an encrypting operation is performed in which the data file is divided into multiple subparts and the subparts are stored on separate mesh storage devices on the network. For example, if there are 5 mesh storage devices on the network, a data file transferred for storage in the encryption mode could be parsed into five subparts, with each subpart stored on a separate mesh storage device. In other examples, the data file could be partitioned into 50, 500, 5000, or any number of subparts that are randomly stored across the mesh storage devices on the network in conjunction with an identifying schema that provides a basis for locating the subparts and reconstructing the data file upon request for retrieval. In addition to this distributed encryption scheme, the subparts of the data file can be further encrypted by other encryption schemes, for example, with symmetric or asymmetric keys or any other method.

In the alternative, if a data retrieval request is received, the various subparts of a distributed data file must be located, retrieved, and decrypted but putting the subparts of the date file back together in the correct order pursuant to a reversal of the encryption schema. If additional encryption operations were performed on the data in the data file, such other corresponding decryption processes must also be employed. If all of the mesh storage devices registered on the network at the time of encryption and storage are not available at the time of a retrieval request, it is impossible to reconstruct the data file because a portion of the data file is not available for reconstruction.

Returning to the first query operation 504, if the network, or a particular readd/write request, is not subject to an encryption configuration, the method 500 may perform a third query operation 512 to determine whether the mesh storage network is configured in a redundancy mode. If not, the method 500 advances to a read/write operation 514 in which a requested data file is retrieved from the mesh storage device on which it is stored or, in the case of a request to store a data file, the data file is stored on the data storage drive of another mesh storage device. The choice of which mesh storage device on which to store the data file can be determined by a variety of hierarchical or weighted factors including, for example, physically closest node, strongest communication signal, type of file (e.g., audio, video, other data), mesh storage device storage capacity, the mesh storage device current communication traffic level, etc.

If the network is determined to be configured in redundancy mode in the third query operation 512, the method 500 advances to a determining operation 516 in which the read and write load on each of the mesh storage devices in the network is determined. Then, in a fourth query operation 518, a determination is made as to whether the data transfer operation is a read or write request. If the user device requests a data file previously stored on the mesh storage network, an identifying operation 520 determines which mesh storage device has the least present data transfer demand and that node is selected to read out the requested data. Note that the present configuration of the mesh storage network is set to a redundant mode such that copies of all data files are stored on each of the mesh storage devices on the network. In some example implementations, the configuration could be altered such that, for example, two copies of a data file are stored within the network. In such a case, the selection of the mesh storage device to handle the retrieval request would be made between the two mesh storage devices storing the data file. In some situations, due to network connectivity issues, data retrieval requests may be transferred, in advance or midstream, to a different mesh storage device than originally selected.

Returning to fourth query operation 518, if a write request is indicated, in a writing operation 522, the data file may be first written to a mesh storage device having a least current read/write demand to provide the quickest process for storing the data file. One the data file is initially stored, then multiple instances of data file can be copied from the initial storage location and stored upon multiple ones, or all, of the mesh storage devices forming the mesh storage network to provide the desired redundancy. Such copying and storage distribution can be performed in the background when communication traffic and storage demand on the mesh storage network is low.

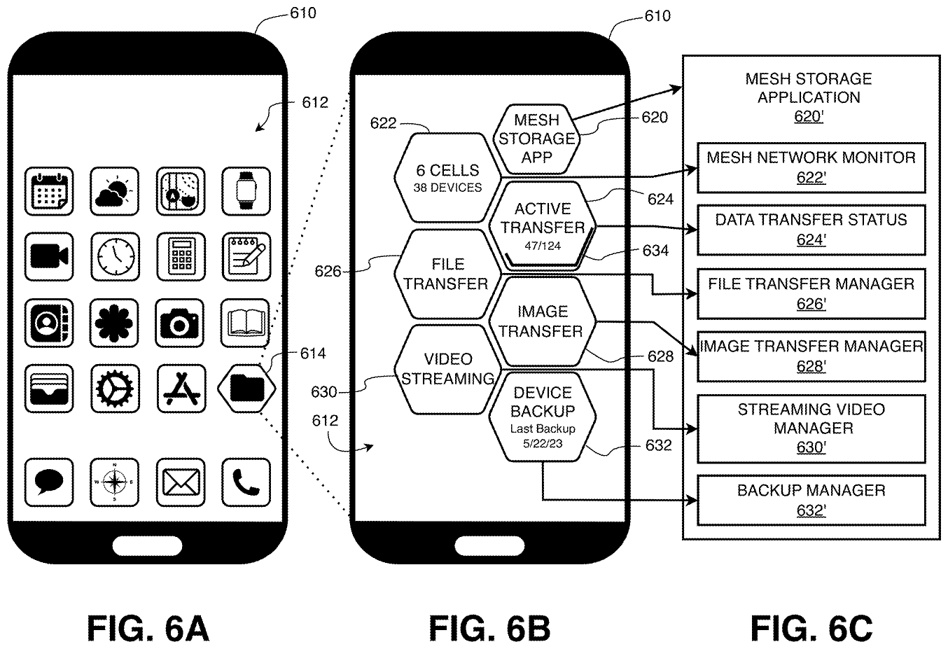

FIGS. 6A-6C together schematically depict an example implementation of a control application for a mesh storage network configured for access on a computing device 610, e.g., a smartphone or tablet computer. As with typical mobile computing devices, a display screen 612 is provided with a graphical user interface (GUI). The display screen 612 may include an interactive touch interface. The GUI displays a variety of software applications that may be instantiated on the computing device 610. In this example, an application icon 614 may be displayed for accessing a management application for a mesh storage network.

Upon user selection of the application icon 614, the management application may be instantiated and a different GUI specific to operation of the management application may be presented on the display screen 612. The management application may be presented in the new GUI as a mesh storage application icon 620 that represents a corresponding mesh storage software application 620′ stored in memory on the computing device 610 as indicated in FIG. 6C. When instantiated, the mesh storage application 620′ may be composed of several separate functional modules. For example, selection of a network status icon 622 in the GUI on the display screen 612 of FIG. 6B instantiates a mesh network monitor 622′ within the mesh storage application 620′. The mesh network monitor 622′ can provide a representation of all network nodes (i.e., mesh network storage devices) on the network, as well as all user devices connected to the network, which may be summarized within the network status icon 622 as shown in FIG. 6B. The mesh network monitor 622′ may also provide current operational statistics for each of the mesh network storage devices, for example, present storage level and remaining capacity.

Selection of an activity icon 624 within the GUI of FIG. 6B instantiates a data transfer status manager 624′ within the mesh storage application 620′ as depicted in FIG. 6C. The data transfer status manager 624′ may show the current status of any read or write requests within the network, including which mesh storage devices are actively receiving or transmitting data, the total amount of data to be transferred in the request, the status of such data transfer, remaining time for transfer, and other metrics. As depicted in FIG. 6B, the data transfer status manager 624′ may also provide a status bar 634 within the activity icon 624 for a summary notification of data transfer status to the user.

Selection of a file transfer icon 626 within the GUI of FIG. 6B instantiates a file transfer manager module 626′ within the mesh storage application 620′ as depicted in FIG. 6C. In one aspect, the file transfer manager 626′ provides a first interface for selection of files stored locally on the user device for transfer to and storage within the mesh storage network. In another aspect, the file transfer manager 626′ provides a second interface for selection of files stored within the mesh storage network for transfer to the user device. The file transfer manager 626′ may further provide functionality for configuration of redundant storage or encrypted storage options as previously described herein. Selection of these options could be, for example, on a global basis, a device-specific basis, or a file-specific basis.

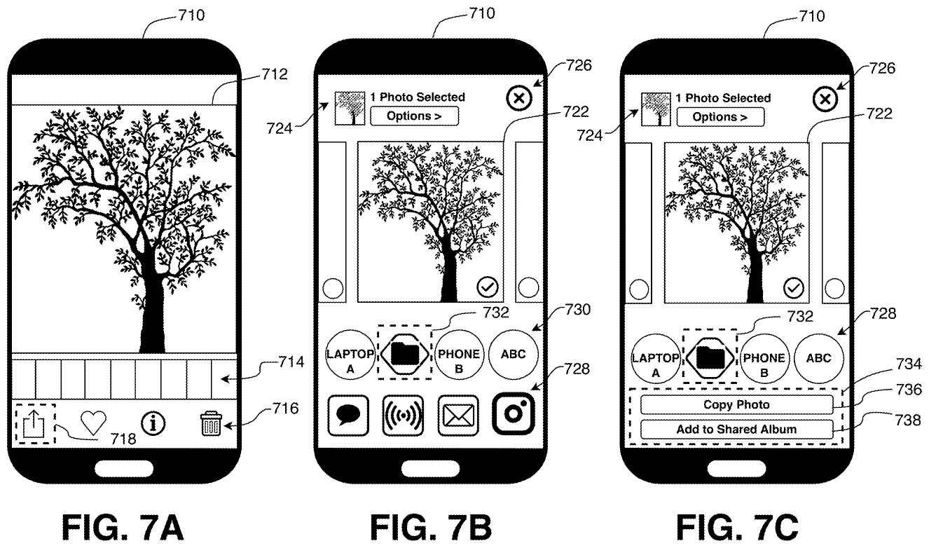

Selection of an image transfer icon 628 within the GUI of FIG. 6B instantiates an image transfer manager 628′ within the mesh storage application 620′ as depicted in FIG. 6C. The image transfer manager 628′ provides an interface for selection of photograph and video files stored locally on the user device and functionality to transfer such image files to the mesh storage network for storage and local access by any user device or presentation device on the network. An example of such an interface for image transfer and related functionality is discussed below with respect to FIGS. 7A-7C. As noted with respect to FIG. 3 the mesh storage devices may each be equipped with a video processor to aid in compression of image files for storage on the network and for scaling of the image files, video files in particular, for appropriate and efficient presentation on a user device or presentation device.

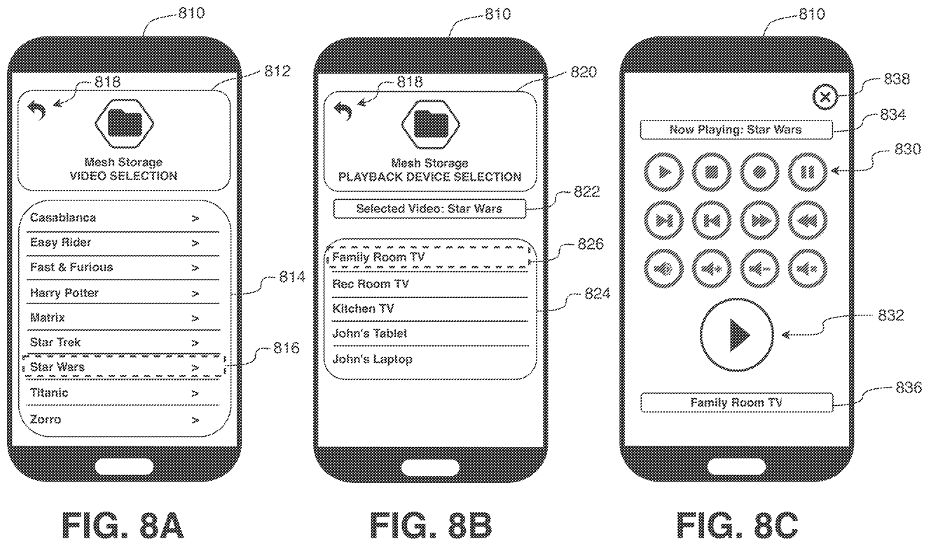

To facilitate presentation of video and other image files, a video streaming icon 630 within the GUI of FIG. 6B instantiates, upon selection, a streaming video manager 630′ within the mesh storage application 620′ as depicted in FIG. 6C. The streaming video manager 630′ provides an interface for selection of video files stored on the mesh network for a streaming presentation and, concurrently, a presentation device connected on the network to receive the video stream for presentation. The presentation device can be a television with WIFI® capability or the user device. As noted, a video processor within the mesh storage device streaming the video file can aid in scaling of the video for appropriate and efficient presentation on the selected presentation device. The streaming video manager 630′ may further provide playback control through the GUI on the display screen 612 of the computing device 610 as further described with respect to FIGS. 8A-8C.

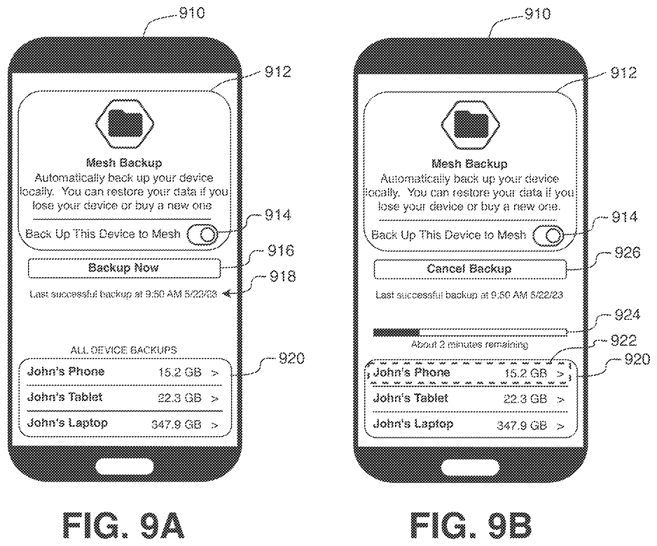

Selection of a device backup icon 632 within the GUI of FIG. 6B instantiates a backup manager module 632′ within the mesh storage application 620′ as depicted in FIG. 6C. The backup manager module 632′ provides a simple way to back up the stored data stored and the configuration settings of any user device connected within the mesh storage network. The backup manager module 632′ may leverage device operating system functionality (e.g., Apple IOS, Google Android, Apple Mac OS, Microsoft Windows, etc.) through specific application protocol interfaces (APIs) to seamlessly backup data and configuration information from a user device. An example of such an interface for user device backup management and related functionality is discussed below with respect to FIGS. 9A-9B.

FIGS. 7A-7C together schematically depict an example implementation of an image transfer management module 628′ of the mesh storage application 620′ of FIGS. 6A-6C for storing digital photographs or videos on the mesh storage network. A user device 710 is depicted in FIG. 7A executing a typical image management application. A photograph 712 is presented in the GUI as a presented photograph from among a plurality of photographs in a photo library 714 schematically represented in the GUI. Additional functional features of the image management application are indicated at the bottom of the GUI and may include an image delete function icon 716 (represented by the typical trash can) and a cooperative application function icon 718 as depicted.

Selection of the cooperative application function icon 718 instantiates a new interface within the GUI on the user device 710 as depicted in FIG. 7B. In this interface, the photograph 712 is depicted as a selected photograph within the plurality of photographs in the photo library. Confirmation of selection of the photograph 722 is indicated in the top bar 724 of the GUI along with an exit button 726 allowing the user to cancel the functionality presented in the GUI of FIG. 7B. Beneath the selected photograph 722 are two rows of available functional icons. The lower row is composed of application icons 728 indicating additional applications on the user device 710 that have capabilities for ingestion and manipulation or inclusion of the selected photograph 722 in features of the applications.

The upper row is a list of devices connected to the LAN or able to connect with the user device 710 via Bluetooth® or other NFC protocol. Among these device icons is a mesh storage network icon 732 which, upon selection, provides functionality for transfer and storage of the selected photograph (or any other image file or collection of image files) to the mesh storage network. Upon selection of the mesh storage network icon 732, the GUI may change as shown in FIG. 7C to replace the row of application icons 728 with storage selection functions 734. For example, the user may be provided a copy option 736 that merely quickly copies the selected photograph 722 to a general photo library maintained within the mesh storage network. As another example, a curation option 738 may be provide that allows the user to organize image files stored within the mesh storage network and, in this example, select a particular album within the library on the mesh storage network to store the selected photograph within. Other functionality for image storage and management on the mesh storage network may be provided through the mesh storage application 620′ and this is merely an example of an implementation.

FIGS. 8A-8C together schematically depict an example implementation of streaming video manager 630′ of the mesh storage application 620′ of FIGS. 6A-6C for streaming playback of a video file stored on a mesh storage network. An example user device 810 is depicted in FIGS. 8A-8C with GUI representations of functional steps and features of the streaming video manager 630′. In FIG. 8A, a user is presented with a video selection interface 812 which displays a video library listing 814, listing video files stored and maintained on the mesh storage network. Any of the video files may be selected for streaming playback (or for download to a user device, but this functionality is not shown in the present example). As indicated by the dashed box in FIG. 8A, a selected video file 816 (in this example, the movie “Star Wars”) has been chosen by the user for streaming playback. The video selection interface 812 also allows a user to return to a prior menu at any time by selection of the return icon 818.

Upon selection of a video title, the streaming video manager 630′ presents a new GUI with a presentation device selection interface 820, an example of which is depicted in FIG. 8B. The presentation device selection interface 820 provides and title indication 822 of the previously selected video title, and further presents a device list 824 of available presentation devices connected to the mesh storage network and available to use for streaming playback. As indicated by the dashed box in FIG. 8B, a selected device 826 (in this example, the “Family Room TV”) has been chosen by the user for streaming playback.

Upon selection of a presentation device, the streaming video manager 630′ presents a new GUI with a playback control interface 830 as depicted in FIG. 8C. The playback control interface 830 can provide a variety of control options (for example, play, pause, stop, fast forward, rewind, and volume control, among others) for controlling streaming playback of the selected video file on the selected presentation device. While some of the control options in the playback control interface 830 will control the streaming operations through a video processor on one of the mesh storage devices within the network as described above, the streaming video manager 630′ can further be provisioned with APIs for interfacing with a wide variety of presentation devices (e.g., televisions, stereo systems, etc.) for controlling local environmental aspects of playback, including audio volume control in particular. As shown in FIG. 8C, the GUI may further provide function status indicator 832 (i.e., if the video is playing or paused), a title indicator 834 listing the video title presently streaming, and a device indicator 836 indicating the selected presentation device for streaming playback. An exit button 838 may also be provided allowing the user to cancel the playback functionality presented in the GUI of FIG. 8C.

FIGS. 9A-9B together schematically depict an example implementation of a backup manager module 632′ within the mesh storage application 620′ as depicted in FIG. 6C. A user device 910 is depicted in FIGS. 9A-9B with GUI representations of functional steps and features of the backup manager module 632′. In FIG. 9A, a user is presented with a mesh backup interface 912 which may include a toggle switch 914 or similar functionality allowing the user to choose whether or not to back up the user device 910 to the mesh storage network. As an example, a user may be able to select an immediate backup function 916. (Alternative scheduled back up functionality may also be provided but is not shown in this example.) A prior status indicator 918 may be presented within the GUI indicating the prior backup date and time for the user device 910. Additionally, a backup log 920 may be provided indicating all devices backed up on the mesh storage network for review of prior or current backup status of each, as well as the amount of data from each device stored within the mesh storage network.

If the immediate backup function 916 is selected (or during a scheduled backup), the GUI presented by the backup manager module 632′ may change to the example interface depicted in FIG. 9B. In this interface, the user device 910 is specifically identified 922 in the backup log 920 (e.g., by visually highlighting the device name) to indicate it is presently being backed up. During a backup session, ac current status indicator 924 may show the status of the backup process, e.g., the estimated time remaining to transfer the data and device configuration files (or incremental changes thereto) onto the mesh storage network. The interface may further provide the users with a cancellation option 926 to stop a backup session at any time.

In some implementations, articles of manufacture are provided as computer program products that cause the instantiation of operations on a computer system to implement the procedural operations. One implementation of a computer program product provides a non-transitory computer program storage medium readable by a computer system and encoding a computer program. The described technology may be employed in special purpose devices independent of a personal computer.

In some example implementations, a mesh storage device is implemented within a local area network and includes a computing processor; a communication transceiver under control of the computing processor; and a data storage drive under control of the computing processor that stores instructions, which when executed by the processor, direct the computing processor to execute application programs in coordination with a plurality of peer mesh storage devices simultaneously wirelessly connected together and with the mesh storage device to form the local area network, the application programs including: a file transfer manager which, when executed by the computing processor, causes the computing processor to: receive a first data file from a user device connected to the local area network, and store the first data file on the data storage drive, on one or more of the plurality of mesh storage devices; and retrieve a second data file requested by the user device from storage on the data storage drive, on one or more of the plurality of mesh storage devices, and cause the retrieved second data file to be transmitted over the local area network to the user device.

In another example implementation of the mesh storage device, the application programs further include a redundant storage manager which, when executed by the computing processor, and in response to the request to retrieve the second data file, causes the computing processor to: determine read and write loads on the data storage drive and also on the peer mesh storage devices; identify one mesh storage device among the mesh storage drive and the peer mesh storage devices with a least data transfer demand and a copy of the second data file stored thereon as a selected mesh storage device; and instruct the selected mesh storage device to retrieve and transmit the second data file over the local area network to the user device.

In another example implementation of the mesh storage device, the application programs further include a redundant storage manager which, when executed by the computing processor, and in response to receipt of the first data file, causes the computing processor to: determine read and write loads on the data storage drive and also on the peer mesh storage devices; identify one mesh storage device among the mesh storage device and the peer mesh storage devices with a least data transfer demand and adequate storage space to store the first data file as a selected mesh storage device; route the first data file over the local area network to the selected mesh storage device; and instruct the selected mesh storage device to store the first data file thereon.

In another example implementation of the mesh storage device, the application programs further include an encryption manager which, when executed by the computing processor, and in response to receipt of the first data file, causes the computing processor to: determine whether the peer mesh storage devices and the mesh storage device constitute mesh storage devices registered on the local area network; and if so, partition the first data file into subparts and distribute the subparts between the mesh storage devices registered on the local area network for storage of one or more respective subparts on respective ones of the data storage drive and peer the mesh storage devices; or if not, deny storage of the first data file on the data storage drive and on any of the peer mesh storage devices.

In another example implementation of the mesh storage device, the application programs further include an encryption manager which, when executed by the computing processor, and in response to the request to retrieve the second data file, causes the computing processor to: determine whether the peer mesh storage devices and the mesh storage device constitute mesh storage devices registered on the local area network; and if so, coordinate with the mesh storage devices registered on the local area network to locate a plurality of subparts of the second data file, wherein one or more respective subparts are stored on respective ones of the data storage drive and the peer mesh storage devices; retrieve the plurality of subparts of the second data file from the data storage drive and the peer mesh storage devices; reconstruct the second data file from the retrieved subparts to form a reconstructed second data file; and transmit the reconstructed second data file to the user device; or if not, deny retrieval of the subparts of the second data file from the data storage drive and the peer mesh storage devices.

In another example implementation of the mesh storage device, the application programs further include a storage capacity manager which, when executed by the computing processor, and in response to the request to retrieve the second data file, causes the computing processor to: evaluate data storage levels for the data storage drive and the peer mesh storage devices; and upon determination that a data storage level for the data storage drive or one of the peer mesh storage devices exceeds a storage threshold level, direct the data storage drive or the one of the peer mesh storage devices exceeding the storage threshold level to transfer data to others of the peer mesh storage devices; and notify the user device of the exceeding of the storage threshold level by the data storage drive or the one of the peer mesh storage devices.

In another example implementation of the mesh storage device, the application programs further include a storage integrity manager which, when executed by the computing processor, and in response to the request to retrieve the second data file, causes the computing processor to: evaluate data storage integrity for the data storage drive and the peer mesh storage devices; and upon determination that an integrity factor for the data storage drive or one of the peer mesh storage devices indicates a likelihood of a fault in performance of the data storage drive or one of the peer mesh storage devices, direct the data storage drive or the one of the peer mesh storage devices indicating a likelihood of the fault to transfer data to others of the peer mesh storage devices; and notify the user device of the likelihood of the fault in the data storage drive or the one of the peer mesh storage devices.

In some example implementations, a mesh wireless storage system provides distributed storage on a local area network comprising a network access device and a plurality of peer mesh storages devices simultaneously wirelessly connected together to form the local area network. The peer mesh storage devices each include a computing processor; a communication transceiver under control of the computing processor; and a data storage drive under control of the computing processor that stores instructions, which when executed by the computing processor, direct the computing processor to execute application programs in coordination with the plurality of peer mesh storage devices. The application programs include a file transfer manager which, when executed by the computing processor, causes the computing processor to receive a first data file from a user device connected to the local area network, and store the first data file on the data storage drive of one or more of the plurality of mesh storage devices, and retrieve a second data file requested by the user device from storage on the data storage drive of one or more of the plurality of mesh storage devices and cause the retrieved second data file to be transmitted over the local area network to the user device.

In another example implementation of the mesh storage system, the application programs further include a redundant storage manager which, when executed by the computing processor of one or more of the peer mesh storage devices, and in response to the request to retrieve the second data file, causes the computing processor to: determine read and write loads on data storage drives of the peer mesh storage devices; identify one mesh storage device among the peer mesh storage devices with a least data transfer demand and a copy of the second data file stored thereon as a selected mesh storage device; and instruct the selected mesh storage device to retrieve and transmit the second data file over the local area network to the user device.

In another example implementation of the mesh storage system, the application programs further include a redundant storage manager which, when executed by the computing processor of one or more of the peer mesh storage devices in response to a request to the system from the user device to store the first data file on the system, causes the computing processor to: determine read and write loads on the data storage drives of the peer mesh storage devices; identify one mesh storage device among the peer mesh storage devices with a least data transfer demand and adequate storage space to store the first data file as a selected mesh storage device; route the first data file over the local area network to the selected mesh storage device; and instruct the selected mesh storage device to store the first data file thereon.

In another example implementation of the mesh storage system, the application programs further include an encryption manager which, when executed by the computing processor of one or more of the peer mesh storage devices in response to a request to the system from the user device to store the first data file on the system, causes the computing processor to: determine whether the peer mesh storage devices constitute mesh storage devices registered on the local area network; and if so, partition the first data file into subparts and distribute the subparts between the mesh storage devices registered on the local area network for storage of one or more respective subparts on respective ones of the data storage drive of peer the mesh storage devices; or if not, deny storage of the first data file on any of the peer mesh storage devices.

In another example implementation of the mesh storage system, the application programs further include an encryption manager which, when executed by the computing processor of one or more of the peer mesh storage devices in response to a request to the system from the user device to retrieve the second data file, causes the computing processor to: determine whether the peer mesh storage devices constitute mesh storage devices registered on the local area network; and if so, coordinate with the peer mesh storage devices registered on the local area network to locate a plurality of subparts of the second data file, wherein one or more respective subparts are stored on respective ones of the peer mesh storage devices; retrieve the plurality of subparts of the second data file from the data storage drive of the peer mesh storage devices; reconstruct the second data file from the retrieved subparts to form a reconstructed second data file; and transmit the reconstructed second data file to the user device; or if not, deny retrieval of the subparts of the second data file from the data storage drive of the peer mesh storage devices.

In another example implementation of the mesh storage system, the application programs further include a storage capacity manager which, when executed by the computing processor, and in response to the request to retrieve the second data file, causes the computing processor to: evaluate data storage levels for the data storage drive and the peer mesh storage devices; and upon determination that a data storage level for the data storage drive or one of the peer mesh storage devices exceeds a storage threshold level, direct the data storage drive or the one of the peer mesh storage devices exceeding the storage threshold level to transfer data to others of the peer mesh storage devices; and notify the user device of the exceeding of the storage threshold level by the data storage drive or the one of the peer mesh storage devices.

In another example implementation of the mesh storage system, the application programs further include a storage integrity manager which, when executed by the computing processor of one or more of the peer mesh storage devices in response to a request to the system from the user device to retrieve the second data file, causes the computing processor to: evaluate data storage integrity for the data storage drive of the peer mesh storage devices; and upon determination that an integrity factor for the data storage drive of one of the peer mesh storage devices indicates a likelihood of a fault in performance of the data storage drive of the one of the peer mesh storage devices, direct the data storage drive of the one of the peer mesh storage devices indicating a likelihood of the fault to transfer data to others of the peer mesh storage devices; and notify the user device of the likelihood of the fault in the data storage drive of the one of the peer mesh storage devices.

In other example implementations, methods are disclosed for providing distributed storage on a wireless local area network formed by a plurality of peer mesh storage devices simultaneously wirelessly connected together. Each of the plurality of peer mesh storage devices includes a computing processor, a communication transceiver, and a data storage drive. The method includes receiving a first data file from a user device connected to the local area network at one of a plurality of peer mesh storage devices; storing the first data file on the data storage drive of one or more of the plurality of mesh storage devices; retrieving a second data file requested by the user device from storage on the data storage drive of one or more of the plurality of mesh storage devices; and transmitting the retrieved second data file over the local area network to the user device.

Another example implementation of the method further includes determining read and write loads on the data storage drives of the peer mesh storage devices; identifying one mesh storage device among the peer mesh storage devices with a least data transfer demand and a copy of the second data file stored thereon as a selected mesh storage device; and instructing the selected mesh storage device to retrieve the second data file from the data storage drive of the selected mesh storage device; and transmitting the second data file over the local area network to the user device.

Another example implementation of the method further includes determining read and write loads on the data storage drives of the peer mesh storage devices; identifying one mesh storage device among the peer mesh storage devices with a least data transfer demand and adequate storage space to store the first data file as a selected mesh storage device; routing the first data file over the local area network to the selected mesh storage device; and instructing the selected mesh storage device to store the first data file in the data storage drive thereof.

Another example implementation of the method further includes determining whether the peer mesh storage devices constitute mesh storage devices registered on the local area network; and if so, partitioning the first data file into subparts; and distributing the subparts between the peer mesh storage devices registered on the local area network for storage of one or more respective subparts on respective ones of the data storage drives of peer the mesh storage devices; or if not, denying storage of the first data file on any of the peer mesh storage devices.

Another example implementation of the method further includes determining whether the peer mesh storage devices constitute mesh storage devices registered on the local area network; and if so, coordinating with the peer mesh storage devices registered on the local area network to locating a plurality of subparts of the second data file, wherein one or more respective subparts are stored on respective ones of the peer mesh storage devices; retrieving the plurality of subparts of the second data file from the data storage drive of the peer mesh storage devices; reconstructing the second data file from the retrieved subparts to form a reconstructed second data file; and transmitting the reconstructed second data file to the user device; or if not, denying retrieval of the subparts of the second data file from the data storage drive of the peer mesh storage devices.

Another example implementation of the method further includes evaluating data storage levels for the data storage drives of the peer mesh storage devices; and upon determining that a data storage level for the data storage drive of one of the peer mesh storage devices exceeds a storage threshold level, directing the data storage drive of the one of the peer mesh storage devices exceeding the storage threshold level to transfer data to others of the peer mesh storage devices; and notifying the user device of the exceeding of the storage threshold level by the data storage drive or the one of the peer mesh storage devices.

Connection references (e.g., attached, coupled, connected, and joined) are to be construed broadly and may include intermediate members between a collection of elements and relative movement between elements unless otherwise indicated. As such, connection references do not infer that two elements are directly connected and in fixed relation to each other. The exemplary drawings are for purposes of illustration and the dimensions, positions, order and relative sizes reflected in the drawings attached hereto may vary.

The above specification, examples and data provide a complete description of the structure and use of various implementations of the present disclosure. Although various implementations have been described above with a given degree of particularity, or with reference to one or more individual embodiments, other implementations using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative of particular implementations and not limiting. Changes in detail or structure may be made without departing from the basic elements of the invention as defined in the following claims and/or any claim arising from the present disclosure.

What is claimed is:

1. A mesh storage device implemented within a local area network comprising:
a computing processor;
a communication transceiver under control of the computing processor; and
a data storage drive under control of the computing processor that stores instructions, which when executed by the processor, direct the computing processor to execute application programs in coordination with a plurality of peer mesh storage devices simultaneously wirelessly connected together and with the mesh storage device to form the local area network, the application programs including:
a file transfer manager which, when executed by the computing processor, causes the computing processor to:
receive a first data file from a user device connected to the local area network, and store the first data file on the data storage drive, on one or more of the plurality of mesh storage devices; and
retrieve a second data file requested by the user device from storage on the data storage drive, on one or more of the plurality of mesh storage devices, and cause the retrieved second data file to be transmitted over the local area network to the user device.

2. The mesh storage device of claim 1, wherein the application programs further include
a redundant storage manager which, when executed by the computing processor, and in response to the request to retrieve the second data file, causes the computing processor to:
determine read and write loads on the data storage drive and also on the peer mesh storage devices;
identify one mesh storage device among the mesh storage drive and the peer mesh storage devices with a least data transfer demand and a copy of the second data file stored thereon as a selected mesh storage device; and
instruct the selected mesh storage device to retrieve and transmit the second data file over the local area network to the user device.

3. The mesh storage device of claim 1, wherein the application programs further include a redundant storage manager which, when executed by the computing processor, and in response to receipt of the first data file, causes the computing processor to:
determine read and write loads on the data storage drive and also on the peer mesh storage devices;
identify one mesh storage device among the mesh storage device and the peer mesh storage devices with a least data transfer demand and adequate storage space to store the first data file as a selected mesh storage device;
route the first data file over the local area network to the selected mesh storage device; and
instruct the selected mesh storage device to store the first data file thereon.

4. The mesh storage device of claim 1, wherein the application programs further include an encryption manager which, when executed by the computing processor, and in response to receipt of the first data file, causes the computing processor to:
determine whether the peer mesh storage devices and the mesh storage device constitute mesh storage devices registered on the local area network; and
if so, partition the first data file into subparts and distribute the subparts between the mesh storage devices registered on the local area network for storage of one or more respective subparts on respective ones of the data storage drive and peer the mesh storage devices; or
if not, deny storage of the first data file on the data storage drive and on any of the peer mesh storage devices.

5. The mesh storage device of claim 1, wherein the application programs further include an encryption manager which, when executed by the computing processor, and in response to the request to retrieve the second data file, causes the computing processor to:
determine whether the peer mesh storage devices and the mesh storage device constitute mesh storage devices registered on the local area network; and
if so, coordinate with the mesh storage devices registered on the local area network to
locate a plurality of subparts of the second data file, wherein one or more respective subparts are stored on respective ones of the data storage drive and the peer mesh storage devices;
retrieve the plurality of subparts of the second data file from the data storage drive and the peer mesh storage devices;
reconstruct the second data file from the retrieved subparts to form a reconstructed second data file; and
transmit the reconstructed second data file to the user device; or
if not, deny retrieval of the subparts of the second data file from the data storage drive and the peer mesh storage devices.

6. The mesh storage device of claim 1, wherein the application programs further include a storage capacity manager which, when executed by the computing processor, and in response to the request to retrieve the second data file, causes the computing processor to:
evaluate data storage levels for the data storage drive and the peer mesh storage devices; and
upon determination that a data storage level for the data storage drive or one of the peer mesh storage devices exceeds a storage threshold level,
direct the data storage drive or the one of the peer mesh storage devices exceeding the storage threshold level to transfer data to others of the peer mesh storage devices; and
notify the user device of the exceeding of the storage threshold level by the data storage drive or the one of the peer mesh storage devices.

7. The mesh storage device of claim 1, wherein the application programs further include a storage integrity manager which, when executed by the computing processor, and in response to the request to retrieve the second data file, causes the computing processor to:
evaluate data storage integrity for the data storage drive and the peer mesh storage devices; and
upon determination that an integrity factor for the data storage drive or one of the peer mesh storage devices indicates a likelihood of a fault in performance of the data storage drive or one of the peer mesh storage devices,
direct the data storage drive or the one of the peer mesh storage devices indicating a likelihood of the fault to transfer data to others of the peer mesh storage devices; and
notify the user device of the likelihood of the fault in the data storage drive or the one of the peer mesh storage devices.

8. A mesh wireless storage system providing distributed storage on a local area network comprising
a network access device; and
a plurality of peer mesh storages devices simultaneously wirelessly connected together to form the local area network, wherein the peer mesh storage devices include:
a computing processor;
a communication transceiver under control of the computing processor; and
a data storage drive under control of the computing processor that stores instructions, which when executed by the computing processor, direct the computing processor to execute application programs in coordination with the plurality of peer mesh storage devices, the application programs including:
a file transfer manager which, when executed by the computing processor, causes the computing processor to:
receive a first data file from a user device connected to the local area network, and store the first data file on the data storage drive of one or more of the plurality of mesh storage devices; and
retrieve a second data file requested by the user device from storage on the data storage drive of one or more of the plurality of mesh storage devices and cause the retrieved second data file to be transmitted over the local area network to the user device.

9. The system of claim 8, wherein the application programs further include a redundant storage manager which, when executed by the computing processor of one or more of the peer mesh storage devices, and in response to the request to retrieve the second data file, causes the computing processor to:
determine read and write loads on data storage drives of the peer mesh storage devices;
identify one mesh storage device among the peer mesh storage devices with a least data transfer demand and a copy of the second data file stored thereon as a selected mesh storage device; and
instruct the selected mesh storage device to retrieve and transmit the second data file over the local area network to the user device.

10. The system of claim 8, wherein the application programs further include a redundant storage manager which, when executed by the computing processor of one or more of the peer mesh storage devices in response to a request to the system from the user device to store the first data file on the system, causes the computing processor to:
determine read and write loads on the data storage drives of the peer mesh storage devices;
identify one mesh storage device among the peer mesh storage devices with a least data transfer demand and adequate storage space to store the first data file as a selected mesh storage device;
route the first data file over the local area network to the selected mesh storage device; and
instruct the selected mesh storage device to store the first data file thereon.

11. The system of claim 8, wherein the application programs further include an encryption manager which, when executed by the computing processor of one or more of the peer mesh storage devices in response to a request to the system from the user device to store the first data file on the system, causes the computing processor to:
determine whether the peer mesh storage devices constitute mesh storage devices registered on the local area network; and
if so, partition the first data file into subparts and distribute the subparts between the mesh storage devices registered on the local area network for storage of one or more respective subparts on respective ones of the data storage drive of peer the mesh storage devices; or
if not, deny storage of the first data file on any of the peer mesh storage devices.

12. The system of claim 8, wherein the application programs further include an encryption manager which, when executed by the computing processor of one or more of the peer mesh storage devices in response to a request to the system from the user device to retrieve the second data file, causes the computing processor to:
determine whether the peer mesh storage devices constitute mesh storage devices registered on the local area network; and
if so, coordinate with the peer mesh storage devices registered on the local area network to
locate a plurality of subparts of the second data file, wherein one or more respective subparts are stored on respective ones of the peer mesh storage devices;
retrieve the plurality of subparts of the second data file from the data storage drive of the peer mesh storage devices;
reconstruct the second data file from the retrieved subparts to form a reconstructed second data file; and
transmit the reconstructed second data file to the user device; or
if not, deny retrieval of the subparts of the second data file from the data storage drive of the peer mesh storage devices.

13. The system of claim 8, wherein the application programs further include a storage capacity manager which, when executed by the computing processor, and in response to the request to retrieve the second data file, causes the computing processor to:
evaluate data storage levels for the data storage drive and the peer mesh storage devices; and
upon determination that a data storage level for the data storage drive or one of the peer mesh storage devices exceeds a storage threshold level,
direct the data storage drive or the one of the peer mesh storage devices exceeding the storage threshold level to transfer data to others of the peer mesh storage devices; and
notify the user device of the exceeding of the storage threshold level by the data storage drive or the one of the peer mesh storage devices.

14. The system of claim 8, wherein the application programs further include a storage integrity manager which, when executed by the computing processor of one or more of the peer mesh storage devices in response to a request to the system from the user device to retrieve the second data file, causes the computing processor to:
evaluate data storage integrity for the data storage drive of the peer mesh storage devices; and
upon determination that an integrity factor for the data storage drive of one of the peer mesh storage devices indicates a likelihood of a fault in performance of the data storage drive of the one of the peer mesh storage devices,
direct the data storage drive of the one of the peer mesh storage devices indicating a likelihood of the fault to transfer data to others of the peer mesh storage devices; and
notify the user device of the likelihood of the fault in the data storage drive of the one of the peer mesh storage devices.

15. A method for providing distributed storage on a wireless local area network formed by a plurality of peer mesh storage devices simultaneously wirelessly connected together, wherein the plurality of peer mesh storage devices include a computing processor, a communication transceiver, and a data storage drive, the method comprising:
receiving a first data file from a user device connected to the local area network at one of a plurality of peer mesh storage devices;
storing the first data file on the data storage drive of one or more of the plurality of mesh storage devices;
retrieving a second data file requested by the user device from storage on the data storage drive of one or more of the plurality of mesh storage devices; and
transmitting the retrieved second data file over the local area network to the user device.

16. The method of claim 15 further comprising:
determining read and write loads on the data storage drives of the peer mesh storage devices;
identifying one mesh storage device among the peer mesh storage devices with a least data transfer demand and a copy of the second data file stored thereon as a selected mesh storage device; and
instructing the selected mesh storage device to retrieve the second data file from the data storage drive of the selected mesh storage device; and
transmitting the second data file over the local area network to the user device.

17. The method of claim 15 further comprising:
determining read and write loads on the data storage drives of the peer mesh storage devices;
identifying one mesh storage device among the peer mesh storage devices with a least data transfer demand and adequate storage space to store the first data file as a selected mesh storage device;
routing the first data file over the local area network to the selected mesh storage device; and
instructing the selected mesh storage device to store the first data file in the data storage drive thereof.

18. The method of claim 15 further comprising:
determining whether the peer mesh storage devices constitute mesh storage devices registered on the local area network; and if so,
partitioning the first data file into subparts; and
distributing the subparts between the peer mesh storage devices registered on the local area network for storage of one or more respective subparts on respective ones of the data storage drives of peer the mesh storage devices; or
if not, denying storage of the first data file on any of the peer mesh storage devices.

19. The method of claim 15 further comprising:
determining whether the peer mesh storage devices constitute mesh storage devices registered on the local area network; and if so,
coordinating with the peer mesh storage devices registered on the local area network to
locating a plurality of subparts of the second data file, wherein one or more respective subparts are stored on respective ones of the peer mesh storage devices;
retrieving the plurality of subparts of the second data file from the data storage drive of the peer mesh storage devices;
reconstructing the second data file from the retrieved subparts to form a reconstructed second data file; and
transmitting the reconstructed second data file to the user device; or
if not, denying retrieval of the subparts of the second data file from the data storage drive of the peer mesh storage devices.

20. The method of claim 15 further comprising:
evaluating data storage levels for the data storage drives of the peer mesh storage devices; and
upon determining that a data storage level for the data storage drive of one of the peer mesh storage devices exceeds a storage threshold level,
directing the data storage drive of the one of the peer mesh storage devices exceeding the storage threshold level to transfer data to others of the peer mesh storage devices; and
notifying the user device of the exceeding of the storage threshold level by the data storage drive or the one of the peer mesh storage devices.
